(19) United States
(12) Patent Application Publication
(10) Pub. No.: US 2026/0296123 A1
(43) Pub. Date: Oct. 1, 2026

(54) VEHICLE RIDE HEIGHT ADJUSTMENT SYSTEM

(71) Applicant: Ryan Bezanson, Phoenix, AZ (US)

(72) Inventor: Ryan Bezanson, Phoenix, AZ (US)

(21) Appl. No.: 19/629,297

(22) Filed: Mar. 26, 2026

Related U.S. Application Data
(60) Provisional application No. 63/779,013, filed on Mar. 27, 2025.

(51) Int. Cl. B60G 17/027

(52) U.S. Cl. CPC B60G 17/0272; B60G 2500/302; B60G 2800/914

(57) ABSTRACT

A ride height adjustment system is provided. The system includes a vehicle frame with a spring mount coupled to the frame and a height adjuster coupled to the spring mount, the height adjuster including a housing with a moveable adjustment member that extends out of and retracts into the housing. A coil spring is coupled to the adjustment member on one end and to a differential housing on the other end, the differential housing coupled to a lower shock mount. A shock absorber is coupled between the vehicle frame and the lower shock mount. The shock body is fluidly coupled to the height adjuster such that compression of the shock absorber pushes hydraulic fluid into the height adjuster and the adjustable member extends from the housing. Then the ride height of the vehicle frame is increased in response to the adjustable member extending from the housing.

### CROSS REFERENCE TO RELATED APPLICATION[S]

This application claims priority to U.S. Provisional Patent Application Ser. No. 63/779,013, filed Mar. 27, 2025, the disclosure of which is hereby incorporated entirely herein by reference.

### BACKGROUND OF THE INVENTION

### Technical Field

This invention relates generally to a ride height control system and more particularly to a ride height control system controlled by spring rate or spring height.

### State of the Art

The ride height of a vehicle is something that vehicle owners seek to adjust for various reasons. Some prefer lifted vehicles and others prefer lowered vehicles. The ride height is often adjusted by adjusting the spring mount, replacing the spring or other like way of adjusting the ride height and the ride height is maintained. There is a lack of a vehicle ride height adjustment system that allows for adjustment of ride height utilizing a pressurized cylinder.

Accordingly, there is a need for an improved system for adjusting vehicle ride height utilizing a pressurized cylinder.

### SUMMARY OF THE INVENTION

In one embodiment, a ride height adjustment system is provided. In this embodiment, the ride height adjustment system includes a vehicle frame with a spring mount coupled to the vehicle frame. A height adjuster is coupled to the spring mount. The height adjuster comprises a housing with a moveable adjustment member configured to extend out of and retract into the housing. A coil spring is coupled to the adjustment member on a first end and to a differential housing on a second end. The differential housing is coupled to a lower shock mount. A shock absorber having a shock body and a piston rod is coupled between the vehicle frame and the lower shock mount. The shock body is fluidly coupled to the height adjuster with a hose extending from a high-pressure side of the shock body and into the housing of the height adjuster. A switch valve is coupled between the shock body and the hose. The switch valve is configured to move between a closed position and an open position. In the open position, compression of the shock absorber pushes hydraulic fluid through the switch valve, through the hose, and into the housing of the height adjuster. The adjustment member extends from the housing in response to a pressure applied to the adjustment member from the hydraulic fluid pumped into the housing from the shock body. A ride height of the vehicle frame is increased in response to the adjustment member extending from the housing.

In another embodiment, a ride height adjustment system is provided. In this embodiment, the ride height adjustment system includes a vehicle frame with a spring mount coupled to the vehicle frame. A height adjuster is coupled to the spring mount. The height adjuster comprises a housing with a moveable adjustment member configured to extend out of and retract into the housing. A coil spring is coupled to the adjustment member on a first end and to a differential housing on a second end. The differential housing is coupled to a lower shock mount. A shock absorber having a shock body and a piston rod is coupled between the vehicle frame and the lower shock mount. A pump is fluidly coupled to the height adjuster with a pump hose extending from the pump and into the housing of the height adjuster. A pump switch valve is coupled between the pump and the pump hose. The pump switch valve is configured to move between a closed position and an open position. In the open position, the pump is configured to pump hydraulic fluid through the pump hose and into the housing of the height adjuster. The adjustment member extends from the housing in response to a pressure applied to the adjustment member from the hydraulic fluid pumped into the housing from the pump. A ride height of the vehicle frame is increased in response to the adjustment member extending from the housing.

In yet another embodiment, a method of adjusting a ride height of a vehicle is provided. In this embodiment, the method includes providing a ride height adjustment system comprising a vehicle frame with a spring mount coupled to the vehicle frame. The system further comprises a height adjuster coupled to the spring mount. The height adjuster comprises a housing with a moveable adjustment member configured to extend out of and retract into the housing. A coil spring is coupled to the adjustment member on a first end and to a differential housing on a second end. The differential housing is coupled to a lower shock mount. A shock absorber having a shock body and a piston rod is coupled between the vehicle frame and the lower shock mount. The shock body is fluidly coupled to the height adjuster with a hose extending from a high-pressure side of the shock body and into the housing of the height adjuster. A pump is fluidly coupled to the height adjuster with a pump hose extending from the pump and into the housing of the height adjuster. A switch valve is coupled between the shock body and the hose. A pump switch valve is coupled between the pump and the pump hose. The method further includes operating the system in at least one of a first mode comprising opening the switch valve such that compression of the shock absorber pushes hydraulic fluid through the switch valve, through the hose, and into the housing of the height adjuster, a second mode comprising opening the pump switch valve and activating the pump to pump hydraulic fluid through the pump hose and into the housing of the height adjuster, or a third mode comprising opening both the switch valve and the pump switch valve simultaneously.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a side view of prior art system of a vehicle spring and shock absorber;

FIG. 2A is a side view of a vehicle ride height adjustment system in a first position according to an embodiment;

FIG. 2B is a side view of a vehicle ride height adjustment system in a second position according to an embodiment;

FIG. 3A is a side view of a vehicle ride height adjustment system in a first position according to an embodiment;

FIG. 3B is a side view of a vehicle ride height adjustment system in a second position according to an embodiment;

FIG. 4A is a side view of a vehicle ride height adjustment system in a first position according to an embodiment;

FIG. 4B is a side view of a vehicle ride height adjustment system in a second position according to an embodiment; and

FIG. 5 is a diagrammatic view of a vehicle ride height adjustment system according to an embodiment.

### DETAILED DESCRIPTION OF EMBODIMENTS OF THE INVENTION

As discussed above, embodiments of the present invention relate to a vehicle ride height adjustment system. The system operates to utilize a pressurized cylinder in the form of a shock absorber to provide the means for adjusting the ride height of a vehicle.

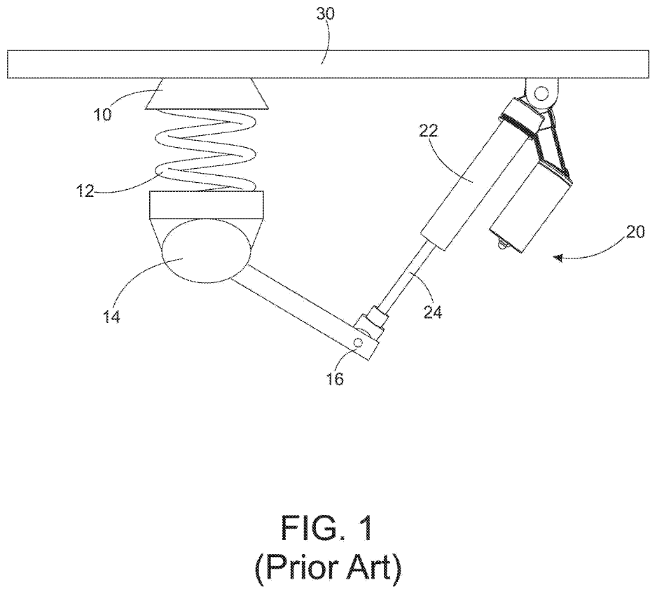

A prior art suspension system for a vehicle is shown in FIG. 1. The conventional suspension include a vehicle frame 30 with a spring mount 10 coupled to the vehicle frame 30. A coil spring 12 is coupled to the spring mount 10 on a first end and to a differential housing 14 on a second end. A lower shock mount 16 is coupled to the differential housing 14. A shock absorber 20 having a shock body 22 and a piston rod 24 is coupled between the vehicle frame 30 and the lower shock mount 16. The conventional suspension does not have a means to adjust ride height and in order to do so, conventional means would include modifying the spring mount 10 or replacing the coil spring 12. There is not a means to adjust the ride height on demand. Accordingly, the present invention is needed.

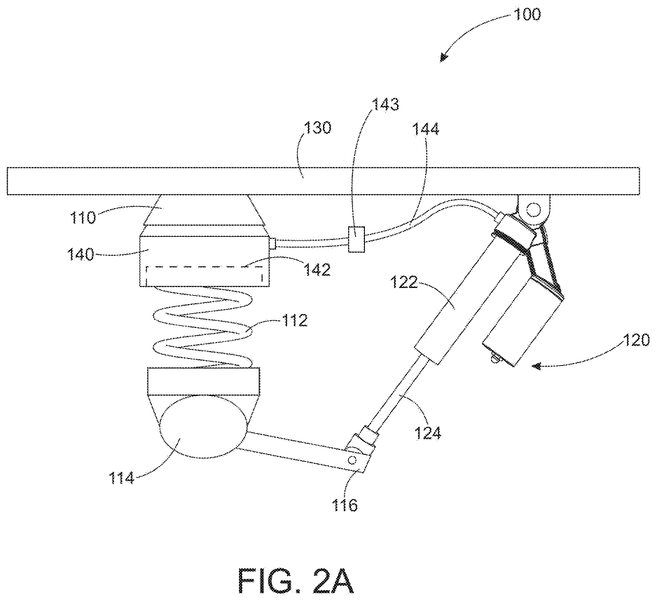

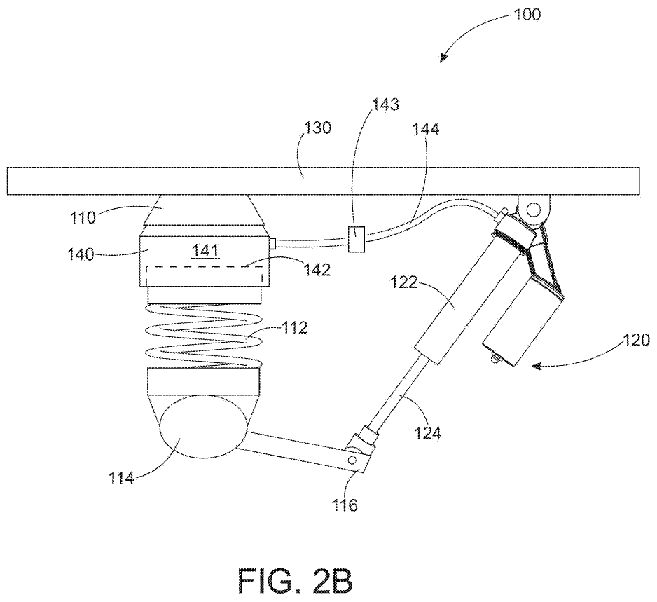

Referring to FIGS. 2A-2B, an embodiment of a ride height adjustment system 100 is depicted. The system 100 includes a vehicle frame 130 with a spring mount 110 coupled to the vehicle frame 130. A height adjuster 140 may be coupled to the spring mount 110 (or in some embodiments, the spring mount and height adjuster 140 are a singular component). The height adjuster 140 comprises a housing 141 with a moveable adjustment member 142 configured to extend out of and retract into the housing 141. A coil spring 112 is coupled to adjustment member 142 of the height adjuster 140 on a first end and to a differential housing 114 on a second end. A lower shock mount 116 is coupled to the differential housing 114. A shock absorber 120 having a shock body 122 and a piston rod 124 is coupled between the vehicle frame 130 and the lower shock mount 116. The shock body 122 may be fluidly coupled to the height adjuster 140 with a hose 144 extending from a high pressure side of the shock body 122 and into the housing 141 of the height adjuster 140. The system 100 may optionally include a pump 146 (either with a reservoir or coupled to a reservoir that is not shown) that is fluidly coupled to the height adjuster 140 by a pump hose 148. In this optional embodiment, the shock body 122 is not fluidly coupled to the height adjuster 140.

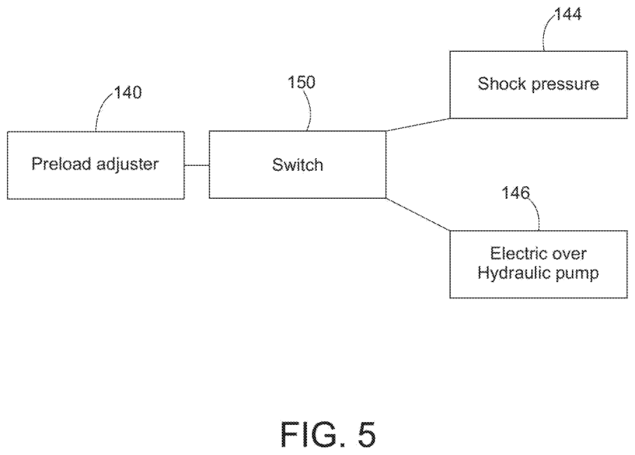

In operation with shock absorber 120 fluidly coupled to the height adjuster 140, the system 100 may be in a first position wherein the adjustment member 142 is retracted within the housing 141 of the height adjuster 140. In this first position, the ride height of the vehicle is a first distance from surface the vehicle is traveling on, which is the closest distance to the surface or lowest ride height. In order to adjust the height, the user may activate a switch 150 (see FIG. 5) that then opens a switch valve 143 (see FIG. 2A). With the switch valve 143 open, the operation of the shock moving in compression pumps hydraulic fluid through the switch valve 143, through hose 144 and into the housing 141 of the height adjuster 140. As the hydraulic fluid flows into the housing 141, the pressure is high enough to extend the adjustment member 142 out of the housing 141 into a second position, as shown in FIG. 2B. In this second position, the ride height of the vehicle is a second distance from a surface the vehicle is traveling on, which is the furthest distance from the surface or highest ride height. Accordingly, the first position is lower than the second position.

This embodiment of the system 100 may be ideally operated in conditions that are rocky or otherwise results in the suspension being compressed often where a higher ride height is desirable. The constant compression of the shock absorber 120 allows the hydraulic fluid to continually maintain the high pressure to keep the height adjuster 140 in the second position providing greater clearance and less likelihood of vehicle frame damage from a bottom out event or the like. Additionally, the driver may activate the switch 150 to close the switch valve 143 to maintain the high-pressure hydraulic fluid in the housing 141 to maintain the ride height of the second position.

Once the terrain being travelled results in less compression of the shock absorber 120, or the desire for the vehicle to travel at the ride height of the first position, the switch 150 activated to open the switch valve 143 or maintain the switch valve 143 open, the pressure will reduce in the hydraulic fluid and the weight of the vehicle will force the adjustment member 142 to retract into the housing 141 of the height adjuster 140. The hydraulic fluid will then flow from the housing 141 back to the shock body. Then the vehicle ride height returns to the first position, the switch 150 may be deactivated to close the switch valve 143, thereby retaining the height adjuster in the first position and the vehicle in the corresponding ride height.

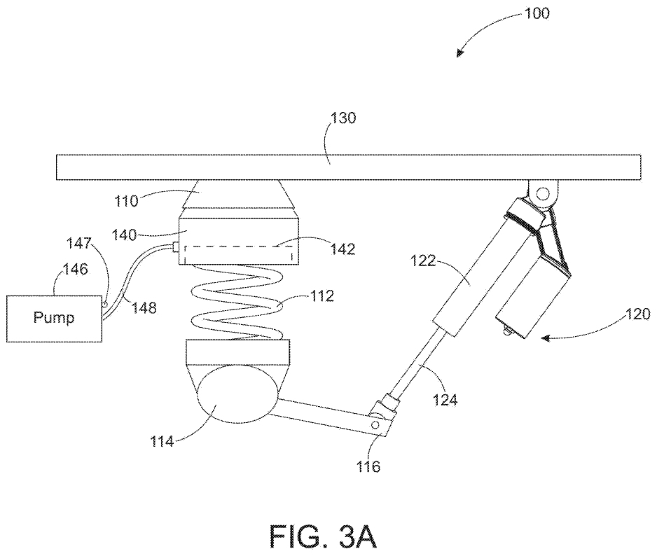

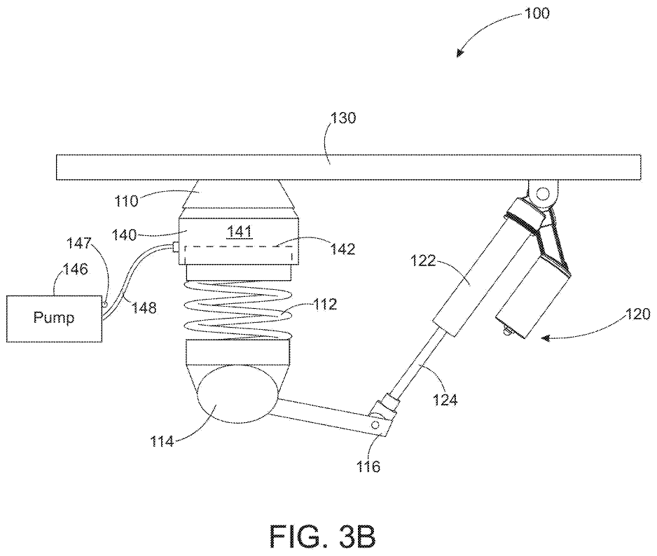

Referring to FIGS. 3A-3B, an embodiment of a ride height adjustment system 100 is depicted. The system 100 includes a vehicle frame 130 with a spring mount 110 coupled to the vehicle frame 130. A height adjuster 140 may be coupled to the spring mount 110 (or in some embodiments, the spring mount and height adjuster 140 are a singular component). The height adjuster 140 comprises a housing 141 with a moveable adjustment member 142 configured to extend out of and retract into the housing 141. A coil spring 112 is coupled to adjustment member 142 of the height adjuster 140 on a first end and to a differential housing 114 on a second end. A lower shock mount 116 is coupled to the differential housing 114. A shock absorber 120 having a shock body 122 and a piston rod 124 is coupled between the vehicle frame 130 and the lower shock mount 116. The system 100 may also include a pump 146 (either with a reservoir or coupled to a reservoir that is not shown) that is fluidly coupled to the height adjuster 140 by a pump hose 148. In this optional embodiment, the shock body 122 is not fluidly coupled to the height adjuster 140.

In operation with pump 146 fluidly coupled to the height adjuster 140, the system 100 may be in a first position wherein the adjustment member 142 is retracted within the housing 141 of the height adjuster 140. In this first position, the ride height of the vehicle is a first distance from surface the vehicle is traveling on, which is the closest distance to the surface or lowest ride height. In order to adjust the height, the user may activate a switch 150 (see FIG. 5) that then opens a pump switch valve 147 (see FIG. 3A). With the pump switch valve 147 open, the switch 150 also activates the pump 146 to pump hydraulic fluid through the pump switch valve 147, through hose 148 and into the housing 141 of the height adjuster 140. As the hydraulic fluid flows into the housing 141, the pressure is high enough to extend the adjustment member 142 out of the housing 141 into a second position, as shown in FIG. 3B. In this second position, the ride height of the vehicle is a second distance from a surface the vehicle is traveling on, which is the furthest distance from the surface or highest ride height. Accordingly, the first position is lower than the second position. Once the second position is reached, the switch 150 may be deactivated closing the pump switch valve 147 and stopping pump 146, thereby maintaining the pressure of the hydraulic fluid within the housing 141 and keeping the height adjuster 140 in the second position.

This embodiment of the system 100 may be ideally operated in conditions that are rocky or otherwise results in the suspension being compressed often where a higher ride height is desirable. This allows the hydraulic fluid to continually maintain the high pressure to keep the height adjuster 140 in the second position providing greater clearance and less likelihood of vehicle frame damage from a bottom out event or the like.

Once the terrain being traveled results in less compression of the shock absorber 120, or the desire for the vehicle to travel at the ride height of the first position, the switch 150 may be activated to open the pump switch valve 147 or maintain the pump switch valve 147 open, the pump 146 may be a two way pump and may be activated to pump in the opposite direction to draw hydraulic fluid from the housing 141, or the pump 146 may simply not be activated and the pressure will reduce in the hydraulic fluid and the weight of the vehicle will force the adjustment member 142 to retract into the housing 141 of the height adjuster 140. The hydraulic fluid will then flow from the housing 141 back to the pump 146. Then the vehicle ride height returns to the first position, the switch 150 may be deactivated to close the pump switch valve 147, thereby retaining the height adjuster in the first position and the vehicle in the corresponding ride height.

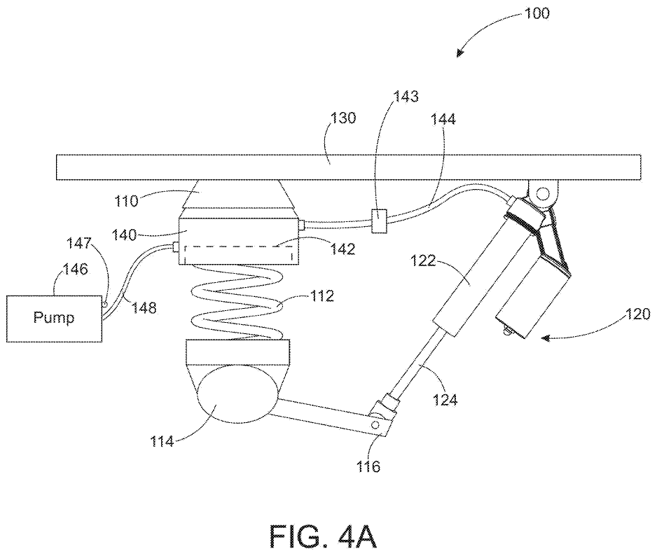

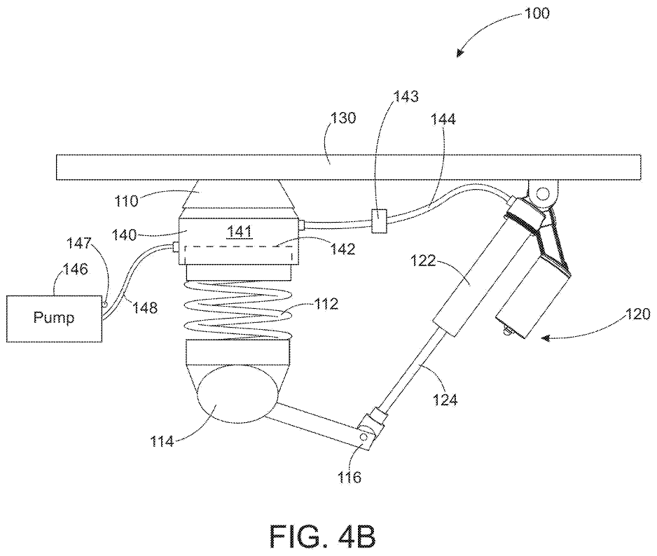

In another embodiment, referring to FIGS. 4A-4B, depicted is a ride height adjustment system 100. The system 100 includes a vehicle frame 130 with a spring mount 110 coupled to the vehicle frame 130. A height adjuster 140 may be coupled to the spring mount 110 (or in some embodiments, the spring mount and height adjuster 140 are a singular component). The height adjuster 140 comprises a housing 141 with a moveable adjustment member 142 configured to extend out of and retract into the housing 141. A coil spring 112 is coupled to adjustment member 142 of the height adjuster 140 on a first end and to a differential housing 114 on a second end. A lower shock mount 116 is coupled to the differential housing 114. A shock absorber 120 having a shock body 122 and a piston rod 124 is coupled between the vehicle frame 130 and the lower shock mount 116. The shock body 122 may be fluidly coupled to the height adjuster 140 with a hose 144 extending from a high pressure side of the shock body 122 and into the housing 141 of the height adjuster 140. The system 100 may also include a pump 146 (either with a reservoir or coupled to a reservoir that is not shown) that is fluidly coupled to the height adjuster 140 by a pump hose 148. In this optional embodiment, the shock body 122 is not fluidly coupled to the height adjuster 140.

In operation, the system 100 may be in a first position wherein the adjustment member 142 is retracted within the housing 141 of the height adjuster 140. In this first position, the ride height of the vehicle is a first distance from surface the vehicle is traveling on, which is the closest distance to the surface or lowest ride height. In order to adjust the height, the user may activate a switch 150 (see FIG. 5) that then opens a switch valve 143, a pump switch valve 147 or both (see FIG. 4A). With the switch valve 143 open, the operation of the shock moving in compression pumps hydraulic fluid through the switch valve 143, through hose 144 and into the housing 141 of the height adjuster 140. With the pump switch valve 147 open, the switch 150 also activates the pump 146 to pump hydraulic fluid through the pump switch valve 147, through hose 148 and into the housing 141 of the height adjuster 140. In this embodiment, hydraulic fluid may flow into the housing from either the shock body 122, the pump 146 or both. As the hydraulic fluid flows into the housing 141, the pressure is high enough to extend the adjustment member 142 out of the housing 141 into a second position, as shown in FIG. 4B. In this second position, the ride height of the vehicle is a second distance from a surface the vehicle is travelling on, which is the furthest distance from the surface or highest ride height. Accordingly, the first position is lower than the second position. Once the second position is reached, the switch 150 may be deactivated closing switch valve 143, the pump switch valve 147 and stopping pump 146, or both, thereby maintaining the pressure of the hydraulic fluid within the housing 141 and keeping the height adjuster 140 in the second position.

This embodiment of the system 100 may be ideally operated in conditions that are rocky or otherwise results in the suspension being compressed often where a higher ride height is desirable. The constant compression of the shock absorber 120 allows the hydraulic fluid to continually maintain the high pressure to keep the height adjuster 140 in the second position providing greater clearance and less likelihood of vehicle frame damage from a bottom out event or the like. Additionally, the driver may activate the switch 150 to close the switch valve 143 to maintain the high-pressure hydraulic fluid in the housing 141 to maintain the ride height of the second position. Further, driver may activate the switch 150 to close the pump switch valve 147 and turn off the pump 146 to maintain the high-pressure hydraulic fluid in the housing 141 to maintain the ride height of the second position. Also, embodiments may include the driver activating the switch 150 to close both the switch valve 143 and the pump switch valve 147 and the pump 146. This allows the hydraulic fluid to continually maintain the high pressure to keep the height adjuster 140 in the second position providing greater clearance and less likelihood of vehicle frame damage from a bottom out event or the like.

Once the terrain being traveled results in less compression of the shock absorber 120, or the desire for the vehicle to travel at the ride height of the first position, the switch 150 activated to open the switch valve 143 or maintain the switch valve 143 open, the pressure will reduce in the hydraulic fluid and the weight of the vehicle will force the adjustment member 142 to retract into the housing 141 of the height adjuster 140. The hydraulic fluid will then flow from the housing 141 back to the shock body. Then the vehicle ride height returns to the first position, the switch 150 may be deactivated to close the switch valve 143, thereby retaining the height adjuster in the first position and the vehicle in the corresponding ride height. Alternatively, the switch 150 may be activated to open the pump switch valve 147 or maintain the pump switch valve 147 open, the pump 146 may be a two way pump and may be activated to pump in the opposite direction to draw hydraulic fluid from the housing 141, or the pump 146 may simply not be activated and the pressure will reduce in the hydraulic fluid and the weight of the vehicle will force the adjustment member 142 to retract into the housing 141 of the height adjuster 140. The hydraulic fluid will then flow from the housing 141 back to the pump 146. Then the vehicle ride height returns to the first position, the switch 150 may be deactivated to close the pump switch valve 147, thereby retaining the height adjuster in the first position and the vehicle in the corresponding ride height. Further still, both of these operations with the switch valve 143 and the pump switch valve 147 with the pump 146 may be operated simultaneously.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A ride height adjustment system comprising:
a vehicle frame with a spring mount coupled to the vehicle frame;
a height adjuster coupled to the spring mount, the height adjuster comprising a housing with a moveable adjustment member configured to extend out of and retract into the housing;
a coil spring coupled to the adjustment member on a first end and to a differential housing on a second end, the differential housing coupled to a lower shock mount;
a shock absorber having a shock body and a piston rod, the shock absorber coupled between the vehicle frame and the lower shock mount, wherein the shock body is fluidly coupled to the height adjuster with a hose extending from a high-pressure side of the shock body and into the housing of the height adjuster; and
a switch valve coupled between the shock body and the hose, wherein:
the switch valve is configured to move between a closed position and an open position;
in the open position, compression of the shock absorber pushes hydraulic fluid through the switch valve, through the hose, and into the housing of the height adjuster;
the adjustment member extends from the housing in response to a pressure applied to the adjustment member from the hydraulic fluid pumped into the housing from the shock body; and
a ride height of the vehicle frame is increased in response to the adjustment member extending from the housing.

2. The ride height adjustment system of claim 1, wherein the adjustment member is configured to retract into the housing in response to a reduction in pressure of the hydraulic fluid within the housing.

3. The ride height adjustment system of claim 1, wherein a weight of the vehicle forces the adjustment member to retract into the housing when the switch valve is in the open position and the shock absorber is not in compression.

4. The ride height adjustment system of claim 1, further comprising a switch configured to control movement of the switch valve between the closed position and the open position.

5. The ride height adjustment system of claim 1, wherein in the closed position, the switch valve is configured to maintain hydraulic fluid pressure within the housing to maintain the ride height of the vehicle frame.

6. The ride height adjustment system of claim 1, wherein the spring mount and the height adjuster are a singular component.

7. The ride height adjustment system of claim 1, wherein the hydraulic fluid flows from the housing back to the shock body when the switch valve is in the open position and pressure in the hydraulic fluid is reduced.

8. A ride height adjustment system comprising:
a vehicle frame with a spring mount coupled to the vehicle frame;
a height adjuster coupled to the spring mount, the height adjuster comprising a housing with a moveable adjustment member configured to extend out of and retract into the housing;
a coil spring coupled to the adjustment member on a first end and to a differential housing on a second end, the differential housing coupled to a lower shock mount;
a shock absorber having a shock body and a piston rod, the shock absorber coupled between the vehicle frame and the lower shock mount;
a pump fluidly coupled to the height adjuster with a pump hose extending from the pump and into the housing of the height adjuster; and
a pump switch valve coupled between the pump and the pump hose, wherein:
the pump switch valve is configured to move between a closed position and an open position;
in the open position, the pump is configured to pump hydraulic fluid through the pump hose and into the housing of the height adjuster;
the adjustment member extends from the housing in response to a pressure applied to the adjustment member from the hydraulic fluid pumped into the housing from the pump; and
a ride height of the vehicle frame is increased in response to the adjustment member extending from the housing.

9. The ride height adjustment system of claim 8, wherein the pump comprises an electric over hydraulic pump.

10. The ride height adjustment system of claim 8, wherein the pump is coupled to a reservoir.

11. The ride height adjustment system of claim 8, wherein the pump is a two-way pump configured to pump hydraulic fluid into the housing in a first direction and draw hydraulic fluid from the housing in a second direction opposite the first direction.

12. The ride height adjustment system of claim 8, further comprising a switch configured to control movement of the pump switch valve between the closed position and the open position and to activate the pump.

13. The ride height adjustment system of claim 8, wherein in the closed position, the pump switch valve is configured to maintain hydraulic fluid pressure within the housing to maintain the ride height of the vehicle frame.

14. The ride height adjustment system of claim 8, wherein the adjustment member is configured to retract into the housing in response to a reduction in pressure of the hydraulic fluid within the housing when the pump is not activated.

15. A method of adjusting a ride height of a vehicle, the method comprising:
providing a ride height adjustment system comprising:
a vehicle frame with a spring mount coupled to the vehicle frame;
a height adjuster coupled to the spring mount, the height adjuster comprising a housing with a moveable adjustment member configured to extend out of and retract into the housing;
a coil spring coupled to the adjustment member on a first end and to a differential housing on a second end, the differential housing coupled to a lower shock mount;
a shock absorber having a shock body and a piston rod, the shock absorber coupled between the vehicle frame and the lower shock mount, wherein the shock body is fluidly coupled to the height adjuster with a hose extending from a high-pressure side of the shock body and into the housing of the height adjuster;
a pump fluidly coupled to the height adjuster with a pump hose extending from the pump and into the housing of the height adjuster;
a switch valve coupled between the shock body and the hose; and
a pump switch valve coupled between the pump and the pump hose; and
operating the system in at least one of:
a first mode comprising opening only the switch valve such that compression of the shock absorber pushes hydraulic fluid through the switch valve, through the hose, and into the housing of the height adjuster;
a second mode comprising opening only the pump switch valve and activating the pump to pump hydraulic fluid through the pump hose and into the housing of the height adjuster; or
a third mode comprising opening both the switch valve and the pump switch valve simultaneously.

16. The method of claim 15, further comprising selectively activating, via a switch, the switch valve, the pump switch valve, or both the switch valve and the pump switch valve.

17. The method of claim 15, wherein the pump comprises an electric over hydraulic pump.

18. The method of claim 15, wherein operating the system in the third mode comprises flowing hydraulic fluid into the housing from both the shock absorber and the pump simultaneously.

19. The method of claim 15, further comprising closing the switch valve and the pump switch valve to maintain hydraulic fluid pressure within the housing to maintain the ride height of the vehicle frame.

20. The method of claim 15, further comprising activating the pump in a reverse direction to draw hydraulic fluid from the housing to reduce the ride height of the vehicle frame.
